(19) United States
(12) Patent Application Publication
(10) Pub. No.: US 2017/0289181 A1
(43) Pub. Date: Oct. 5, 2017

(54) PAYMENT METHOD, APPARATUS AND MEDIUM

(71) Applicant: Beijing Xiaomi Mobile Software Co., Ltd., Beijing (CN)

(72) Inventors: Chenxi WANG, Beijing (CN); Ming LIU, Beijing (CN); Yufei WANG, Beijing (CN)

(21) Appl. No.: 15/461,496

(22) Filed: Mar. 17, 2017

(30) Foreign Application Priority Data
Mar. 31, 2016 (CN) 201610202066.8

(51) Int. Cl. H04L 29/06; G06Q 20/40

(52) U.S. Cl. CPC H04L 63/1416; H04L 63/1425; G06Q 20/405; H04L 2463/102; G06F 3/0481

(57) ABSTRACT

A payment method, apparatus and medium are provided. The method includes: preventing a floating window from being displayed on an interface displayed by a payment application when the payment application is running on foreground; receiving a payment operation triggered by a user on the interface; paying in accordance with the payment operation.

### CROSS-REFERENCE TO RELATED APPLICATIONS

This application is based on and claims a priority to Chinese Patent Application Serial No. 201610202066.8, filed with the State Intellectual Property Office of P. R. China on Mar. 31, 2016, the entire content of which is incorporated herein by reference.

### TECHNICAL FIELD

The present disclosure relates to a computer field, and more particularly to a payment method, apparatus and medium.

### BACKGROUND

With the development of e-commerce, it is more and more popular for a user to pay online with a payment application in a terminal, thus it is more and more important to improve a security during the payment.

Typically, when the user starts the payment application, a covering virus may generate an interface which is the same as a login interface of the payment application and covers the login interface, and the covering virus may acquire an account and a password input on the interface by the user.

### SUMMARY

According to a first aspect of embodiments of the present disclosure, there is provided a payment method, including: preventing a floating window from being displayed on an interface displayed by a payment application when the payment application is running on foreground; receiving a payment operation triggered by a user on the interface; and paying in accordance with the payment operation.

According to a second aspect of embodiments of the present disclosure, there is provided a payment apparatus, including: a processor; a memory configured to store instructions to be implemented by the processor, in which the processor is configured to: prevent a floating window from being displayed on an interface displayed by a payment application when the payment application is running on foreground; receive a payment operation triggered by a user on the interface; and pay in accordance with the payment operation.

According to a third aspect of embodiments of the present disclosure, a non-transitory computer-readable storage medium is provided. The non-transitory computer-readable storage medium has stored therein instructions that, when executed by a processor of a device, causes the device to perform a payment method, the method including:preventing a floating window from being displayed on an interface displayed by a payment application when the payment application is running on foreground; receiving a payment operation triggered by a user on the interface; and paying in accordance with the payment operation

It should be understood that, the above general description and following detail description are illustrative and explanatory, and shall not be construed to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a payment method according to an illustrative embodiment of the present disclosure;

FIG. 2 is a flow chart showing a payment method according to another illustrative embodiment of the present disclosure;

FIG. 3 is a flow chart showing a payment method according to another illustrative embodiment of the present disclosure;

FIG. 4 is a block diagram showing a payment apparatus according to an illustrative embodiment of the present disclosure;

FIG. 5 is a block diagram showing a payment apparatus according to an illustrative embodiment of the present disclosure;

FIG. 6 is a block diagram showing a payment device according to an illustrative embodiment of the present disclosure.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of apparatuses and methods consistent with aspects related to the disclosure as recited in the appended claims.

FIG. 1 is a flow chart showing a payment method according to an illustrative embodiment of the present disclosure. The payment method is applied in a terminal. As shown in FIG. 1, the payment method includes the followings.

In step 101, a floating window is prevented from being displayed on an interface displayed by a payment application when the payment application is running on foreground.

In step 102, a payment operation triggered by a user on the interface is received.

In step 103, a payment is performed in accordance with the payment operation.

In conclusion, according to the payment method provided by the present disclosure, by preventing the floating window from being displayed on the interface displayed by the payment application, the terminal may prevent the fake interface, which is generated by the covering virus and similar to the interface displayed by the payment application, from being displayed when the payment application is running on foreground. Meanwhile, the user may input payment information on the true interface displayed by the payment application, thus the covering virus cannot acquire the payment information by using the fake interface, so as to avoid insecurity of the payment environment caused by the covering virus that generates the fake interface covering the interface displayed by the payment application and acquires the payment information input on the fake interface by the user, thereby improving the security of the payment environment.

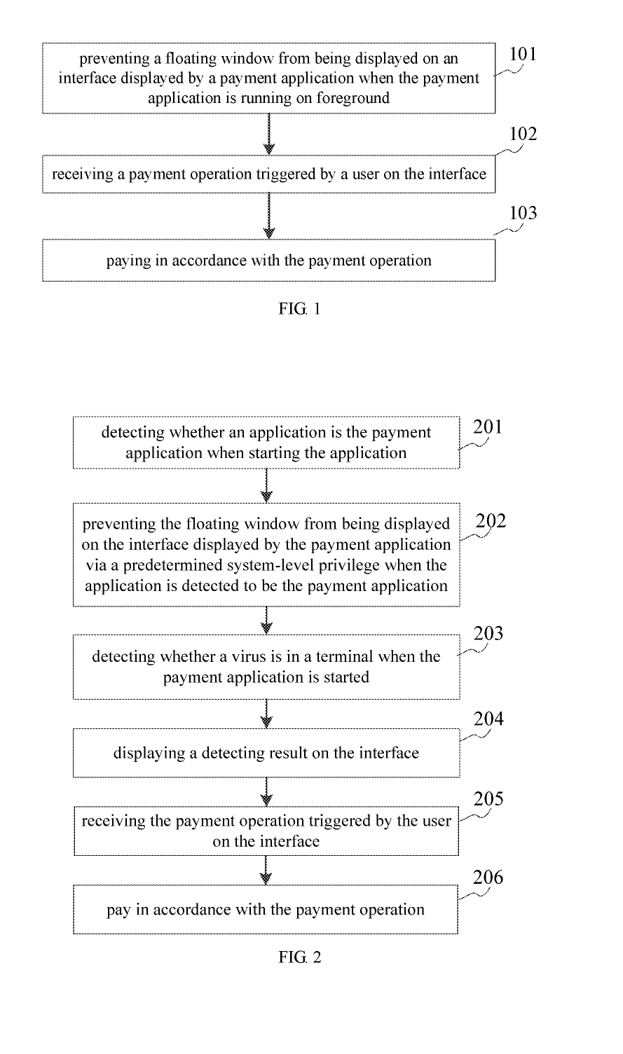

FIG. 2 is a flow chart showing a payment method according to another illustrative embodiment of the present disclosure. The payment method is applied in a terminal. As shown in FIG. 2, the payment method includes the followings.

In step 201, it is detected whether an application is the payment application when the application is started.

When the user starts the application installed in the terminal, the terminal may detect whether the application is the payment application. The payment application is provided for the user to perform operations, such as payment and transfer. The payment application includes a payment client and a payment web, which are not limited on specific forms of the payment application in the embodiments.

The terminal detecting whether the application is the payment application may include: an identifier of the application may be acquired by the terminal; the identifier is detected by the terminal whether to be an identifier of the payment application; and the application is determined by the terminal to be the payment application if the identifier is detected to be the identifier of the payment application. Forms for detecting the application to be the payment application are not limited in the embodiments.

In step 202, when the application is detected to be the payment application, the floating window is prevented from being displayed on the interface displayed by the payment application via a predetermined system-level privilege.

The interface refers to an interface displayed by the payment application when the payment application is running on foreground. The interface is provided to the user for inputting payment information and includes at least one of a login interface and a payment interface. If the interface is the login interface, the payment information should be the login account and the login password for logining the payment application. If the interface is the payment interface, the payment information should be the payment account and the payment password used by the user when paying. The floating window refers to another interface displayed on the interface of the terminal.

The covering virus refers to a virus generating a fake interface that covers on and is similar to the interface displayed by the payment application. Mechanism for generating the fake interface is the same as that of the floating window.

If there is the virus in the terminal, the covering virus may generate the fake interface on the interface displayed by the payment application based on the mechanism for generating the floating window when the payment application is running on foreground. Meanwhile, the user may mistake the fake interface as the interface displayed by the payment application and input the payment information in this fake interface, thus the covering virus may acquire the payment information. In the embodiment, by preventing the floating window from being displayed on the interface displayed by the payment application, the fake interface generated by the covering virus may be prevented by the terminal. In such a way, the user may input the payment information in the true interface displayed by the payment application, so that the covering virus cannot acquire the payment information, thus improving the security of the payment environment.

When the terminal prevents the floating window from being displayed on the interface displayed by the payment application, one possible implementing way is to always prevent the floating window from being displayed on the interface displayed by the terminal via the system-level privilege no matter whether the application running on foreground is the payment application or not. At this time, the floating window cannot be displayed on the interface by other applications except the covering virus, either, which may affect the running of these applications. The system-level privilege is configured to limit the terminal to display the floating window on the interface. The system-level privilege may be set up by the user or may be predetermined by the system, which is not limited in the embodiments.

For example, an app XX manager may remind the user an occupation situation of a memory of the terminal via displaying the floating window on the interface. If the floating window is always prevented to be displayed on the interface by the terminal, the floating window of the app XX manager is also prevented, so that the user cannot learn the occupation situation of the memory of the terminal by the floating window.

Another possible implementing way to prevent the floating window from being displayed on the interface displayed by the payment application via the system-level privilege when the terminal detects that the application running on foreground is the payment application. At this time, the payment information of the user may be protected from being acquired by the covering virus when the payment application is running on foreground, and meanwhile, the floating windows of other applications can be displayed when the payment application is not running on foreground, thus improve the flexibility for preventing the floating window by the terminal. The system-level privilege may be set up by the user when the payment application is downloaded to the terminal or may be predetermined by the system, which is not limited in the embodiments.

For example, the payment application, such as the XX Pay may be running on foreground, at this time the floating window is prevented from being displayed on the interface displayed by the XX pay at the terminal, so that the fake interface generated by the covering virus is prevented to be displayed and the payment information of the user cannot be acquired. When the XX pay is not running on foreground, the terminal allows displaying the floating window and the floating window of the app manager may be displayed on the interface.

In step 203, it is detected whether the virus is in the terminal when the payment application is started.

The virus is a section of executable codes, which is configured to steal information input by the user when the payment operation is triggered by the user. The virus may be the infectious virus such as Trojan, or other non-infectious virus, which is not limited in the embodiments.

For the covering virus, which is possible to be non-detectable by the terminal and is of a same generation mechanism as that of the floating window, in the step 202, by preventing the floating window from being displayed on the interface displayed by the payment application, it avoids the insecurity of the payment environment caused by the fake interface generated by the covering virus. Moreover, for the virus detectable by the terminal, it may be detected when the payment application is running on foreground.

Detecting whether a virus is in a terminal includes: detecting whether an application carrying the virus is installed in the terminal and whether an application running on background receives information carrying the virus; and determining that the virus is in the terminal, when the application carrying the virus is detected to be installed in the terminal or the application running on background is detected to receive the information carrying the virus.

In the embodiments, the security of the payment environment is fully detected in two conditions, whether the application installed in the terminal brings the virus and whether the application running on background of the terminal receives information carrying the virus, thus improving the security of the payment environment.

It should be understood that, step 203 may be performed before step 202, or after step 202, or at the same time with step 202, which is not limited in the embodiments.

In step 204, a detecting result is displayed on the interface.

The detecting result is for the user to determine whether to trigger the payment operation. A display form of the detecting result may be displaying an interface with different colours, in which different colors represent different detecting results; or displaying prompt information on the interface, the prompt information including the detecting result. The display forms of the detecting result are not limited in the embodiments.

For example, when the display form of the detecting result is displaying the interface with specific colour, a red interface represents there is the virus in the terminal and the green one represents there is no virus in the terminal.

For other example, when the display form of the detecting result is displaying the prompt information on the interface, a content of the prompt information may be “virus is present, please search and remove first” or “no virus is detected, please perform”.

In step 205, the payment operation triggered by the user is received.

In step 206, the payment is performed in accordance with the payment operation.

In conclusion, according to the payment method provided by the present disclosure, by preventing the floating window from being displayed on the interface displayed by the payment application, the terminal may prevent the fake interface, which is generated by the covering virus and similar to the interface displayed by the payment application, from being displayed when the payment application is running on foreground. Meanwhile, the user may input payment information on the true interface displayed by the payment application, thus the covering virus cannot acquire the payment information using the fake interface, so as to avoid the insecurity of the payment environment caused by the covering virus that generates the fake interface covering the interface displayed by the payment application and acquires the payment information input on the fake interface by the user, thereby improving the security of the payment environment.

In addition, by detecting whether the application is the payment application when starting the application, and by preventing the floating window from being displayed on the interface displayed by the payment application when the application is detected to be the payment application, the terminal will only prevent the floating window from being displayed on the interface displayed by the payment application when the application running on foreground is the payment application, thus ensuring the security of the payment without preventing the floating window from being displayed by other applications in the terminal and improving flexibility of preventing the floating window from be displayed by the terminal.

In addition, by detecting whether the virus is in the terminal when the payment application is started, and by displaying the detecting result on the interface displayed by the payment application, the user may implement the payment operation when the detecting results indicates that there is no virus in the terminal, thus improving the security of the payment environment.

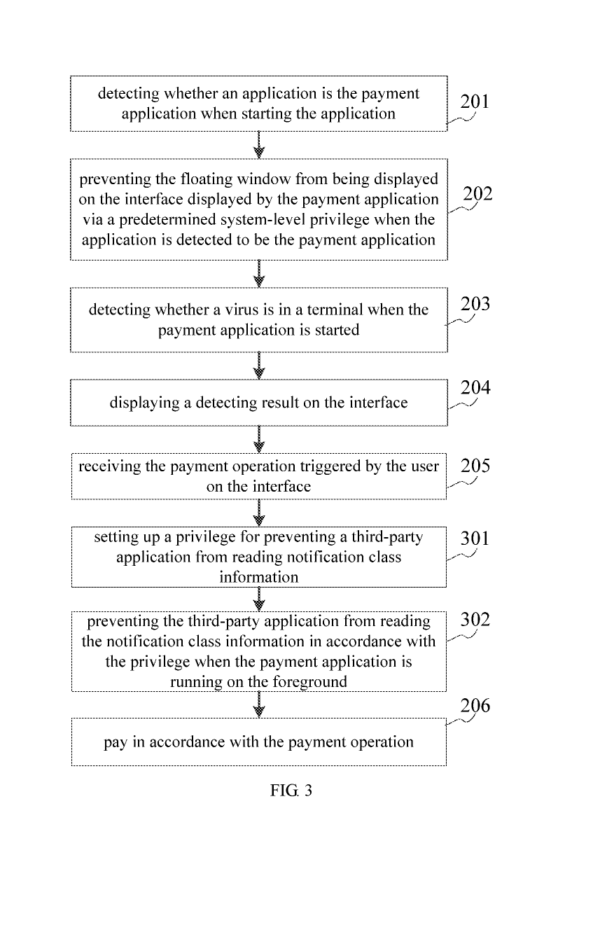

Alternatively, as shown in FIG. 3, to avoid the insecurity because the terminal cannot detect all viruses, before step 206, the payment method may further include the followings.

In step 301, a privilege for preventing a third-party application from reading notification class information is set up.

The third-part application is an application other than the payment application and a system application, and the notification class information is sent from a payment server to the payment application for verifying information of the user.

When setting up the privilege for preventing the third-party application from reading the notification class information, one possible implementing way is that when the third-party application is installed, the privilege for preventing the third-party application from reading the notification class information is set up by the user. Another possible implementing way is that all the third-party application are prevented from reading the notification class information by a terminal set-up. Forms and times of setting up the privilege for preventing the third-party application from reading the notification class information are not limited in the embodiments.

In step 302, the third-party application is prevented from reading the notification class information in accordance with the privilege when the payment application is running on the foreground.

After the user triggers the payment operation on the interface displayed by the payment application, the payment application will send a payment request carrying an identifier of the user to the payment server. After the payment server receives the payment request, it may send the notification class information including a section of verification codes to the terminal bound with the identifier of the user. After the user input the verification code on the interface, the payment application sends it to the payment server for verification. The payment server receives the verification code and detects whether the code received is the same as the code included in the notification class information. If the codes are same, the identity of the user performing the payment operation is authenticated. The identifier of the user is usually a login account of the payment application.

If the third-party application is able to read the notification information sent by the payment server and acquires the account and the password of the user, it may login the account and the password on background, and sends a payment request to the payment server, and the notification class information may be sent back to the terminal by the payment server, meanwhile the third-party application may read the notification class information and send the verification code included in the notification class information to the payment server. In such a way, the identity of the user performing the payment operation may still be authenticated by the payment server, thus causing the insecurity of the payment environment.

It should be understood that, the account described herein may be a login account used to login the payment application, or may be a payment account used to perform the payment. Accordingly, the password described herein may be a login password used to login the payment application, or may be a payment password used to perform the payment. Types of account and password are not limited in the embodiments.

In the embodiments of the present disclosure, by setting up the privilege for preventing the third-party application from reading notification class information, and by preventing the third-party application from reading the notification class information in accordance with the privilege when the payment application is running on the foreground, even if the third-party application acquires the account and the password of the user, it may still cannot read a verification code in the notification class information because it cannot read the notification class information received by the terminal, thus the third-party application cannot send the verification code matching with the account and the password of the user to the payment server and the identity verification of the user of the payment operation by the payment server is not passed, thereby avoiding the insecurity of the payment environment caused by the third-party application that reads the verification code in the notification class information and sends it to the payment server to pass the identity verification of the user of the payment operation, so as to improve the security of the payment environment.

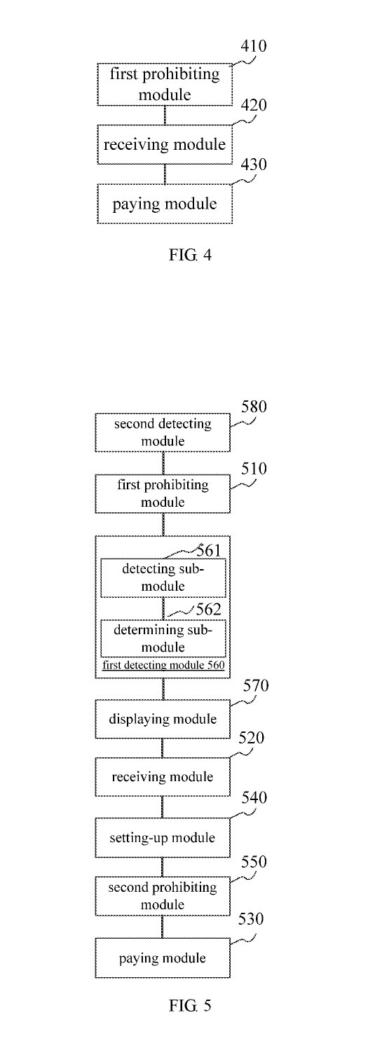

FIG. 4 is a block diagram showing a payment apparatus according to an illustrative embodiment of the present disclosure. The payment apparatus is used in the terminal. As shown in FIG. 4, the payment apparatus includes: a first preventing module 410, a receiving module 420 and a paying module 430.

The first preventing module 410 is configured to prevent a floating window from being displayed on an interface displayed by a payment application when the payment application is running on foreground.

The receiving module 420 is configured to receive a payment operation triggered by a user on the interface.

The paying module 430 is configured to pay in accordance with the payment operation received by the receiving module 420.

In conclusion, according to the payment apparatus provided by the present disclosure, by preventing the floating window from being displayed on the interface displayed by the payment application, the terminal may prevent the fake interface, which is generated by the covering virus and similar to the interface displayed by the payment application, from being displayed when the payment application is running on foreground. Meanwhile, the user may input payment information on the true interface displayed by the payment application, thus the covering virus cannot acquire the payment information using the fake interface, so as to avoid the insecurity of the payment environment caused by the covering virus that generates the fake interface covering the interface displayed by the payment application and acquires the payment information input on the fake interface by the user, thereby improving the security of the payment environment.

FIG. 5 is a block diagram showing a payment apparatus according to an illustrative embodiment of the present disclosure. The payment apparatus is used in the terminal. As shown in FIG. 5, the payment apparatus includes: a first preventing module 510, a receiving module 520 and a paying module 530.

The first preventing module 510 is configured to prevent a floating window from being displayed on an interface displayed by a payment application when the payment application is running on foreground.

The receiving module 520 is configured to receive a payment operation triggered by a user on the interface.

The paying module 530 is configured to pay in accordance with the payment operation received by the receiving module 520.

Alternatively, the first preventing module 510 is further configured to prevent the floating window from being displayed on the interface displayed by the payment application via a predetermined system-level privilege.

Alternatively, the apparatus further includes: a setting-up module 540 and a second preventing module 550.

The setting-up module 540 is configured to set up a privilege for preventing a third-party application from reading notification class information, in which the third-part application is an application other than the payment application and a system application, and the notification class information is sent from a payment server to the payment application for verifying information of the user.

The second preventing module 550 is configured to prevent the third-party application from reading the notification class information in accordance with the privilege set up by the setting-up module 540 when the payment application is running on the foreground.

Alternatively, the apparatus further includes: a first detecting module 560 and a displaying module 570.

The first detecting module 560 is configured to detect whether a virus is in a terminal when the payment application is started, in which the virus is configured to steal information input by the user when the payment operation is triggered.

The displaying module 570 is configured to display a detecting result detected by the first detecting module 560 on the interface, in which the detecting result is for the user to determine whether to trigger the payment operation.

Alternatively, the first detecting module 560 includes a detecting sub-module 561 and a determining sub-module 562.

The detecting sub-module 561 is configured to detect whether an application carrying the virus is installed in the terminal, and whether an application running on background receives information carrying the virus.

The determining sub-module 562 is configured to determine that the virus is in the terminal, when the application carrying the virus is detected by the detecting sub-module 561 to be installed in the terminal or the application running on background is detected by the detecting sub-module 561 to receive the information carrying the virus.

Alternatively, the apparatus further includes: a second detecting module 580.

The second detecting module 580 is configured to detect whether an application is the payment application when starting the application.

The first preventing module 510 is further configured to trigger an act of preventing the floating window from being displayed on the interface displayed by the payment application when the payment application is running on foreground, when the application is detected by the second detecting module 580 to be the payment application.

In conclusion, according to the payment apparatus provided by the present disclosure, by preventing the floating window from being displayed on the interface displayed by the payment application, the terminal may prevent the fake interface, which is generated by the covering virus and similar to the interface displayed by the payment application, from being displayed when the payment application is running on foreground. Meanwhile, the user may input payment information on the true interface displayed by the payment application, thus the covering virus cannot acquire the payment information using the fake interface, so as to avoid the insecurity of the payment environment caused by the covering virus that generates the fake interface covering the interface displayed by the payment application and acquires the payment information input on the fake interface by the user, thereby improving the security of the payment environment.

In addition, by detecting whether the application is the payment application when starting the application, and by preventing the floating window from being displayed on the interface displayed by the payment application when the application is detected to be the payment application, the terminal will only prevent the floating window from being displayed on the interface displayed by the payment application when the application running on foreground is the payment application, thus ensuring the security of the payment without preventing the floating window from being displayed by other applications in the terminal and improving flexibility of preventing the floating window from be displayed by the terminal.

In addition, by detecting whether the virus is in the terminal when the payment application is started, and by displaying the detecting result on the interface displayed by the payment application, the user may implement the payment operation when the detecting results indicates that there is no virus in the terminal, thus improving the security of the payment environment.

In addition, by setting up the privilege for preventing the third-party application from reading notification class information, and by preventing the third-party application from reading the notification class information in accordance with the privilege when the payment application is running on the foreground, even if the third-party application acquires the account and the password of the user, it may still cannot read a verification code in the notification class information because it cannot read the notification class information received by the terminal, thus the third-party application cannot send the verification code matching with the account and the password of the user to the payment server and the identity verification of the user of the payment operation by the payment server is not passed, thereby avoiding the insecurity of the payment environment caused by the third-party application that reads the verification code in the notification class information and sends it to the payment server to pass the identity verification of the user of the payment operation may be solved, so as to improve the security of the payment environment.

With respect to the apparatuses in the above embodiments, the specific manners for performing operations for individual modules therein have been described in detail in the embodiments regarding the methods, which are not elaborated herein again.

According to an illustrative embodiment of the present disclosure, a payment device is provided to realize the payment method provided by the disclosure, and the payment device includes: a processor; a memory configured to store instructions to be implemented by the processor, in which the processor is configured to: prevent a floating window from being displayed on an interface displayed by a payment application when the payment application is running on foreground; receive a payment operation triggered by a user on the interface; and pay in accordance with the payment operation.

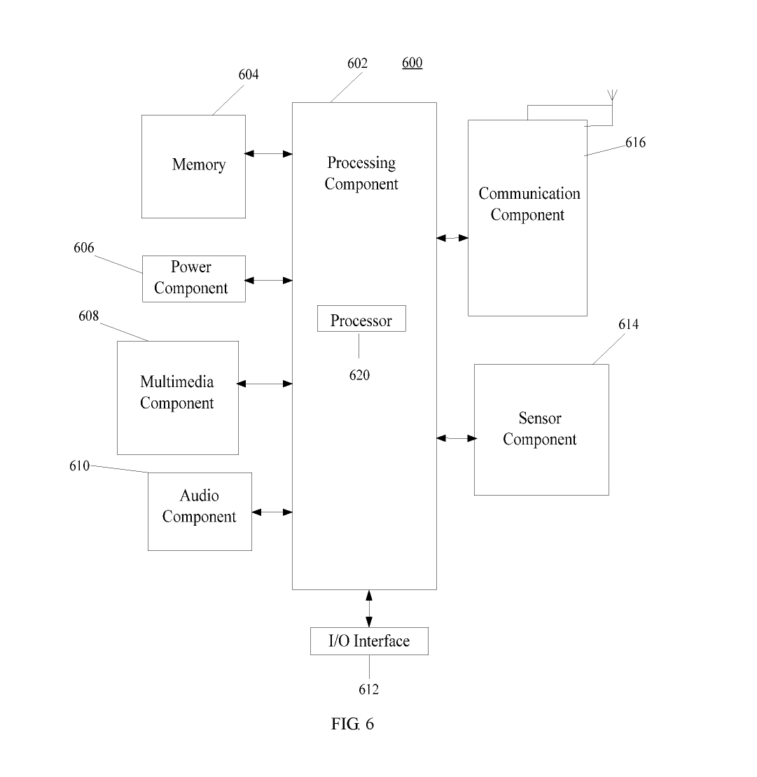

FIG. 6 is a block diagram of a payment device 600 according to an illustrative embodiment. For example, the device 600 may be a mobile phone, a computer, a tablet device, a Personal Digital Assistant PDA, etc.

Referring to FIG. 6, the device 600 may include the following one or more components: a processing component 602, a memory 604, a power component 606, a multimedia component 608, an audio component 610, an Input/Output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and other gestures on the touch panel. The touch sensors may not only sense a boundary of a touch or swipe action, but also sense a duration time and a pressure associated with the touch or swipe action. In some embodiments, the multimedia component 608 includes a front camera and/or a rear camera. The front camera and the rear camera may receive external multimedia data while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (MIC) configured to receive an external audio signal when the intelligent device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface for the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600 and relative positioning of components (e.g. the display and the keypad of the device 600). The sensor component 614 may also detect a change in position of the device 600 or of a component in the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate wired or wireless communication between the device 600 and other devices. The device 600 can access a wireless network based on a communication standard, such as WIFI, 2G; or 3G; or a combination thereof. In one illustrative embodiment, the communication component 616 receives a broadcast signal or broadcast associated information from an external broadcast management system via a broadcast channel. In one illustrative embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In illustrative embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In illustrative embodiments, there is also provided a non-transitory computer readable storage medium including instructions, such as the memory 604 including instructions. The above instructions are executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing form the scope thereof. It is intended that the scope of the disclosure only be limited by the appended claims.

What is claimed is:

1. A payment method, comprising:
preventing a floating window from being displayed on an interface displayed by a payment application when the payment application is running on foreground;
receiving a payment operation triggered by a user on the interface; and
paying in accordance with the payment operation.

2. The method according to claim 1, wherein preventing a floating window from being displayed on an interface displayed by a payment application comprises:
preventing the floating window from being displayed on the interface displayed by the payment application via a predetermined system-level privilege.

3. The method according to claim 1, further comprising:
setting up a privilege for preventing a third-party application from reading notification class information, wherein the third-part application is an application other than the payment application and a system application, and the notification class information is sent from a payment server to the payment application for verifying information of the user; and
preventing the third-party application from reading the notification class information in accordance with the privilege when the payment application is running on the foreground.

4. The method according to claim 1, further comprising:
detecting whether a virus is in a terminal when the payment application is started, wherein the virus is configured to steal information input by the user when the payment operation is triggered; and
displaying a detecting result on the interface for the user to determine whether to trigger the payment operation.

5. The method according to claim 4, wherein detecting whether a virus is in a terminal comprises:
detecting whether an application carrying the virus is installed in the terminal and whether an application running on background receives information carrying the virus; and
determining that the virus is in the terminal, when the application carrying the virus is detected to be installed in the terminal or the application running on background is detected to receive the information carrying the virus.

6. The method according to claim 1, further comprising:
detecting whether an application is the payment application when starting the application; and
triggering an act of preventing the floating window from being displayed on the interface displayed by the payment application when the payment application is running on foreground, when the application is detected to be the payment application.

7. A payment apparatus, comprising:
a processor;
a memory configured to store instructions to be implemented by the processor,
wherein the processor is configured to:
prevent a floating window from being displayed on an interface displayed by a payment application when the payment application is running on foreground;
receive a payment operation triggered by a user on the interface; and
pay in accordance with the payment operation.

8. The payment apparatus according to claim 7, wherein the processor configured to prevent a floating window from being displayed on an interface displayed by a payment application is further configured to:
prevent the floating window from being displayed on the interface displayed by the payment application via a predetermined system-level privilege.

9. The payment apparatus according to claim 7, wherein the processor is further configured to:
set up a privilege for preventing a third-party application from reading notification class information, wherein the third-part application is an application other than the payment application and a system application, and the notification class information is sent from a payment server to the payment application for verifying information of the user; and
prevent the third-party application from reading the notification class information in accordance with the privilege when the payment application is running on the foreground.

10. The payment apparatus according to claim 7, wherein the processor is further configured to:
detect whether a virus is in a terminal when the payment application is started, wherein the virus is configured to steal information input by the user when the payment operation is triggered; and
display a detecting result on the interface for the user to determine whether to trigger the payment operation.

11. The payment apparatus according to claim 10, wherein the processor configured to detect whether a virus is in a terminal is further configured to:
detect whether an application carrying the virus is installed in the terminal and whether an application running on background receives information carrying the virus; and
determine that the virus is in the terminal, when the application carrying the virus is detected to be installed in the terminal or the application running on background is detected to receive the information carrying the virus.

12. The payment apparatus according to claim 7, wherein the processor is further configured to:
detect whether an application is the payment application when starting the application; and
trigger an act of preventing the floating window from being displayed on the interface displayed by the payment application when the payment application is running on foreground, when the application is detected to be the payment application.

13. A non-transitory computer-readable storage medium having stored therein instructions that, when executed by a processor of a device, causes the device to perform a payment method, the method comprising:
preventing a floating window from being displayed on an interface displayed by a payment application when the payment application is running on foreground;
receiving a payment operation triggered by a user on the interface; and
paying in accordance with the payment operation.

14. The non-transitory computer-readable storage medium according to claim 13, wherein preventing a floating window from being displayed on an interface displayed by a payment application comprises:
preventing the floating window from being displayed on the interface displayed by the payment application via a predetermined system-level privilege.

15. The non-transitory computer-readable storage medium according to claim 13, wherein the method further comprises:
setting up a privilege for preventing a third-party application from reading notification class information, wherein the third-part application is an application other than the payment application and a system application, and the notification class information is sent from a payment server to the payment application for verifying information of the user; and
preventing the third-party application from reading the notification class information in accordance with the privilege when the payment application is running on the foreground.

16. The non-transitory computer-readable storage medium according to claim 13, wherein the method further comprises:
detecting whether a virus is in a terminal when the payment application is started, wherein the virus is configured to steal information input by the user when the payment operation is triggered; and
displaying a detecting result on the interface for the user to determine whether to trigger the payment operation.

17. The non-transitory computer-readable storage medium according to claim 16, wherein detecting whether a virus is in a terminal comprises:
detecting whether an application carrying the virus is installed in the terminal and whether an application running on background receives information carrying the virus; and
determining that the virus is in the terminal, when the application carrying the virus is detected to be installed in the terminal or the application running on background is detected to receive the information carrying the virus.

18. The non-transitory computer-readable storage medium according to claim 13, wherein the method further comprises:
detecting whether an application is the payment application when starting the application; and
triggering an act of preventing the floating window from being displayed on the interface displayed by the payment application when the payment application is running on foreground, when the application is detected to be the payment application.
